(19) United States
(12) Patent Application Publication
(10) Pub. No.: US 2015/0178814 A1
(43) Pub. Date: Jun. 25, 2015

(54) METHODS AND SYSTEMS FOR CONDUCTING ONLINE TRANSACTIONS

(71) Applicant: TENCENT TECHNOLOGY (SHENZHEN) COMPANY LIMITED, Shenzhen (CN)

(72) Inventor: MAOCAI LI, Shenzhen (CN)

(73) Assignee: TENCENT TECHNOLOGY (SHENZHEN) COMPANY LIMITED

(21) Appl. No.: 14/639,447

(22) Filed: Mar. 5, 2015

Related U.S. Application Data
(63) Continuation of application No. PCT/CN2014/083180, filed on Jul. 29, 2014.

(30) Foreign Application Priority Data
Oct. 31, 2013 (CN) 2013-10532479.9

(51) Int. Cl. G06Q 30/06; G06Q 20/12

(52) U.S. Cl. CPC G06Q 30/0633; G06Q 20/12

(57) ABSTRACT

A method and system for conducting online transactions are disclosed. The method implemented by a user terminal includes scanning the product label of a product and obtaining product label information; obtaining product information based on the product label information; and generating purchase order information based on the product information. The purchase order information includes a payment method. The method further includes sending the purchase order information to a trading platform and receiving a message indicating the purchase is complete. The method and system consistent with the present disclosure may improve online product purchase processes and user experience in conducting online transactions.

### CROSS-REFERENCES TO RELATED APPLICATIONS

This application is a continuation application of PCT Patent Application No. PCT/CN2014/083180, filed on Jul. 29, 2014, which is based upon and claims the benefit of priority from Chinese Patent Application No. 201310532479.9, filed on Oct. 31, 2013, the entire contents of both of which are incorporated herein by reference.

### FIELD OF THE INVENTION

The present disclosure relates to Internet technologies and, more particularly, to methods and systems for conducting online transactions.

### BACKGROUND

As the quality of life improves, grocery stores and super markets are designed to be located close to residential areas so that it is convenient for the residents to fulfill their daily needs, in shops and super markets, shoppers often check the prices of products by reading product labels. Sometimes a shopper may skip a purchase because he does not obtain enough information of the product from simply reading the label. Further, the shopper may need to wait for a cashier to scan a product to make a purchase, or to ask for more information. Such shopping processes are inefficient and have not taken advantages of the intelligence of certain online trading systems.

The disclosed method and system are directed to solve one or more problems set forth above and other problems.

### BRIEF SUMMARY OF THE DISCLOSURE

Embodiments consistent with the present disclosure provide a method, system, mobile device, or a server for conducting transactions, such as product purchases, online.

One aspect of the present disclosure provides a method for conducting online transactions implemented by a user terminal. The method includes scanning a product label of a product and obtaining product label information; obtaining product information based on the product label information; and generating purchase order information based on the product information, the purchase order information including a payment method. The method further includes sending the purchase order information to a trading platform and receiving a message indicating the purchase is completed. The method and system consistent with the present disclosure may improve the product purchase processes and improve user experience in conduct online purchases.

The method may further include adding the product information to a shopping cart, the product information including an identification, a price, and data related to other traits of the product. The method may also include sending user registration information to the trading platform, the user registration information including a contact person's name, telephone number, and address. Moreover, the payment method may be payment on delivery, payment on order, or payment on site. The product label information may include an identification based on a graphic code or NFC technology.

Another aspect of the present disclosure provides a method for conducting online transactions implemented by an online trading platform. The method includes receiving user registration information from a user terminal, the registration information including a contact person's name, telephone number, and address, and storing the user registration information. The method further includes receiving purchase order information from a user terminal, the purchase order information including an identification of a product, a price, and a payment method; managing payment process according to the payment method; and completing the purchase based on the purchase order information.

Further, the method may include authenticating a user based on the stored user registration information. The payment method included in the user registration information may be payment on delivery, payment on order, or payment on site. If the payment method is payment on delivery, the trading platform first distributes the product using the user registration information and then sends a payment interface to the user terminal. If the payment method is payment on order, the trading platform first sends a payment interface to the user terminal and then distributes the product using the user registration information. If the payment method is payment on site, the trading platform sends a payment interface to the user terminal. Finally, the method may include sending a message to the user terminal indicating the purchase is complete.

Another aspect of the present disclosure provides a system for conducting online transactions. The system for conducting online transactions includes a user terminal configured to scan a product label of a product and obtaining product label information. The user terminal may further obtain product information based on the product label information; generate purchase order information based on the product information, the purchase order information including a payment method; send the purchase order information to a trading platform; and receive a message from the trading platform indicating the purchase is completed. In addition, the user terminal may add the product information to a shopping cart, the product information including an identification, a price, and data related to other traits of the product. The user terminal may further send user registration information to the trading platform, the user registration information including a contact person's name, telephone number, and address. The payment method may be payment on delivery, payment on order, or payment on site. The product label information may include an identification of the product based on a graphic code or NFC technology.

In addition, the system may include a trading platform configured to receive user registration information from the user terminal, the registration information including a contact person's name, telephone number, and address. The trading platform may also store the user registration information; receive purchase order information from the user terminal, the purchase order information including an identification of a product, a price, and a payment method; manage payment process according to the payment method; and complete the purchase based on the purchase order information.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for making online transactions implemented by an embodiment consistent with the present disclosure;

FIG. 2 is an exemplary user interface for displaying information of a product implemented by an embodiment consistent with the present disclosure;

FIG. 3 is another flowchart of a method for making online transactions implemented by an embodiment consistent with the present disclosure;

FIG. 4 is another user interface for adding a product into a shopping cart implemented by an embodiment consistent with the present disclosure;

FIG. 5 is another flowchart of a method for making online transactions implemented by an embodiment consistent with the present disclosure;

FIG. 6 is another flowchart of a method for making online transactions implemented by an embodiment consistent with the present disclosure;

FIG. 7 is another flowchart of a method for making online transactions implemented by an embodiment consistent with the present disclosure;

FIG. 8 is another flowchart of a method for making online transactions implemented by an embodiment consistent with the present disclosure;

FIG. 9 is a block diagram of an exemplary user terminal consistent with the present disclosure;

FIG. 10 is another block diagram of an exemplary user terminal consistent with the present disclosure;

FIG. 11 is another block diagram of an exemplary user terminal consistent with the present disclosure;

FIG. 12 is a block diagram of an exemplary trading platform consistent with the present disclosure;

FIG. 13 is another block diagram of an exemplary trading platform consistent with the present disclosure;

FIG. 14 is another block diagram of an exemplary trading platform consistent with the present disclosure; and

FIG. 15 is an exemplary system for conducting online transactions consistent with the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

Embodiments consistent with the present disclosure provide a system for conduction online transactions. In the present disclosure, a user terminal may be a tablet computer, a smartphone, a laptop computer, or other mobile devices or user terminals. An online trading platform may be any software and hardware applications that facilitate the payment, management, registration, and other functions necessary for completing various online transactions such as online purchases. In certain embodiments, the trading platform may also use another system, such as a payment system, to perform some of these functions. For example, a trading platform may use a payment server provided by a third party, such as a bank, to complete the payment process.

Embodiments consistent with the present disclosure may facilitate the shopping process in stores or super markets. For example, a user may use a user terminal to scan the label of a product. The user terminal may further generate an order of the product and send the order to a trading platform. The user terminal may then complete the purchase process with the trading platform. In another example, a user may use a user terminal to scan the label of a product. The user terminal may further generate an order of the product and send the order to a trading platform. The user terminal may then complete the purchase process with the trading platform. In addition, the trading platform may complete the shipping and delivery process for the product.

In other examples, the user terminal may obtain the product information from a display (a physical or online display) of the product. The user terminal may further generate an order of the product and send the order to a trading platform. The user terminal may then complete the purchase process with the trading platform. In addition, the trading platform may complete the shipping and delivery process for the product. By obtaining the product identification information (e.g., scanning a product label), the user terminal may obtain more information about the product from a database. A user may then browse more information related to the product in real time. Further, once the user terminal creates a purchase order and sends the order to the trading platform, the trading platform may manage the purchase using the payment method selected by the user. By enabling users to select different payment methods, the user terminal may also improve the settlement efficiency of the purchases.

Embodiments of the present disclosure may utilize voiceprint, fingerprint, facial data, two-dimensional code and other technologies for certain functions, such as the authentication functions and the product identification functions. The product label may use graphic code, or near field communication (NFC) tags. The graphic code may be a bar code or another two-dimensional code. The product label may be attached to the price tag of a product or the package of a product. The product label may also be a part of the product's online display. The product information may be the manufacturing place, supplier, manufacturing date, expiration date, etc., of the product. The purchase order may include the product information and the payment method selected for the purchase. In certain cases, one product may be offered by two or more sellers. The product information may also include the sellers' account information. Once the user terminal obtains the product information, the user may pick the account of one seller, and completes the purchase with the selected seller through the trading platform. Embodiments consistent with the present disclosure may therefore reduce the steps in the purchasing and payment process.

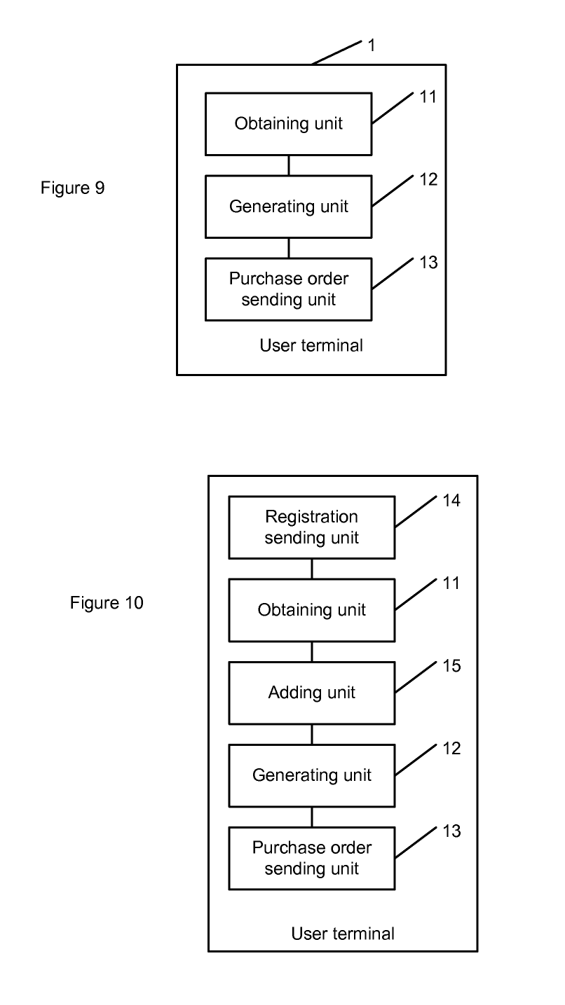

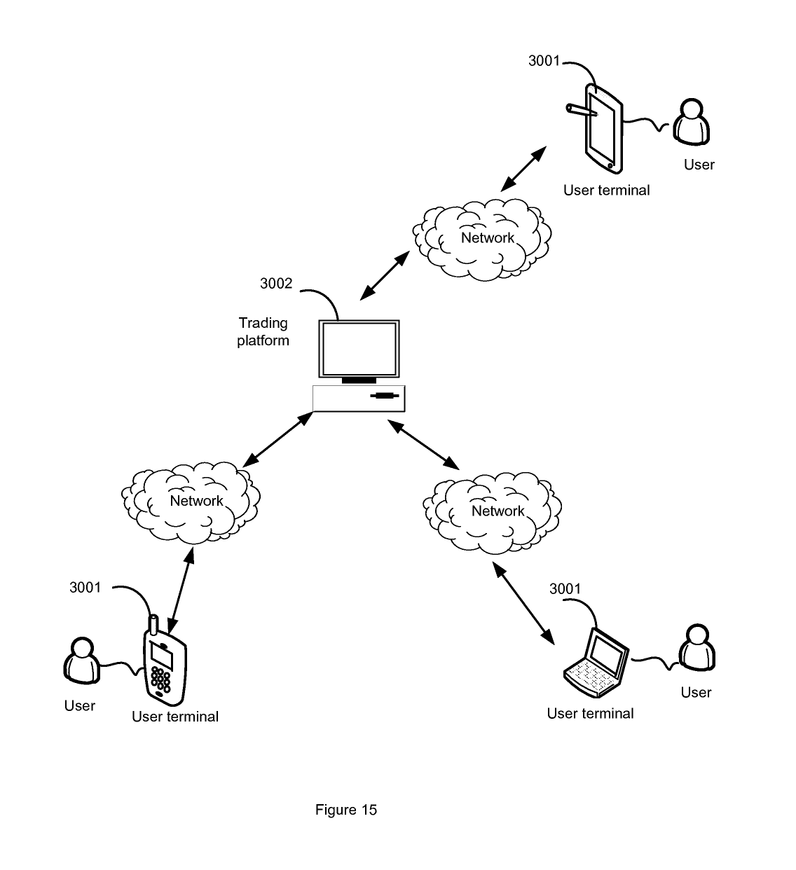

FIG. 15 is a system diagram of a trading platform and multiple user terminals consistent with the present disclosure. As shown in FIG. 15, the system for making online purchases may include user terminals 3001, an online trading platform 3002. The user terminals 3001 are connected to the trading platform 3002. The user terminals 3001 may be any of the user terminals described in relation to FIGS. 9-11 below. The trading platform 3002 may the any of the trading platforms described in relation to FIGS. 12-14 below.

As shown in FIG. 15, the user terminal 3001 may scan product label information. The label information includes product information. The label information may be an identification of the product using a graphic code or an NFC tag. Further, the user terminal 3001 may generate purchase order information. The purchase order information includes product information and a selected payment method for the product. The user terminal 3001 may send the purchase order information to the trading platform 3002. The trading platform 3002 may complete the online purchase according to the payment method specified in the purchase order information.

In some embodiments, the user terminal 3001 may add the product information into a shopping cart. The product information may include an identification of the product, a price, and data related to other product characteristics. If the user intends to purchase the product or keep the product information, he may click an “add to shopping cart” button on the user terminal 3001. The user terminal 3001 may then add the product information into the shopping cart so that the user may access the information or purchase the product later. The product information may include an identification, a prices, and data related to other traits of the product.

In some embodiments, the user terminal 3001 may send a user's registration information to a trading platform 3002. The registration information may include contact information for the user such as a contact person's name, telephone number, and address. Specifically, a user needs to register with the trading platform 3002 before he can make purchases through the trading platform 3002. The user may use the user terminal 3001 to send a request for registration to the trading platform 3002. In response to the request, the trading platform 3002 may send a link to the registration webpage. The user may access the webpage and fill in registration information. The user terminal 3001 may then send the registration information to the trading platform 3002. The trading platform 3002 may then store the registration information and complete the registration process. Upon the completion of the registration process, the user may purchase products through the trading platform 3002.

The user terminal 3001 may send the purchase order information to the trading platform 3002, such as a trading platform hosted by a seller of the product. The user terminal 3001 may send the purchase order information, which includes a payment method chosen for the purchase, to the trading platform 3002. The trading platform 3002 may manage the purchase process accordingly. The method for payment may be payment on delivery, payment on order, or payment on site, etc.

If the payment method is payment on delivery, the trading platform 3002 may first obtain the user information and inform a distributor (such as a store) to ship the product. Once the product is shipped and/or received, the trading platform 3002 may send the user a payment request, requesting the user to complete the payment process on the trading platform 3002. The payment request may include a link to a payment webpage of the trading platform 3002. If the method for payment is payment on order, the trading platform 3002 may send the user a link to the payment webpage. The user may complete the payment process on the user terminal 3001 through the payment webpage. The trading platform 3002 may then use the user information to arrange shipment of the ordered product. The product may be shipped by a distributor of the product, such as a store that sells the product. If the method for payment is payment on site, the trading platform 3002 may send a link to the payment webpage to the user terminal 3001. The user may complete the payment process through the user terminal 3001. The user information may include a contact person's name, phone number, address, etc.

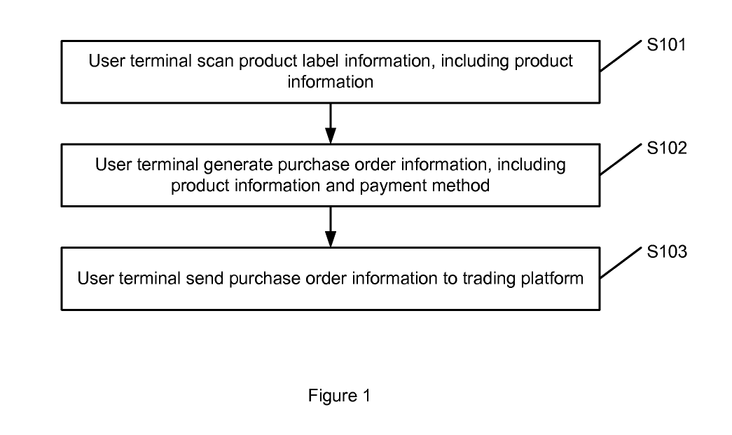

FIGS. 1-8 illustrates the processes implemented by embodiments consistent with the present disclosure. FIG. 1 shows a flow chart of a method for online trading implemented by embodiments consistent with the present disclosure. The method shown in FIG. 1 includes step S101-S103.

In step S101, a user terminal may scan the label information of a product. The label information may include product information. Specifically, a user may use a user terminal to scan a product he intends to purchase. Once the user terminal reads in the product label information, the user terminal may obtain product information based on the label information. For example, the label information may be graphic code information. The user terminal may use a camera and/or a scanner to obtain the label information. The user terminal may use an instant messaging software application, such as a graphics code scanning application, to scan the label information. Alternatively, if the product label is a NFC tag, the user terminal may use a software application that facilitates reading/writing of NFC data to scan the label information. That is, in this case, the instant messaging software (and/or hardware) application used for scanning is the NFC read/write application.

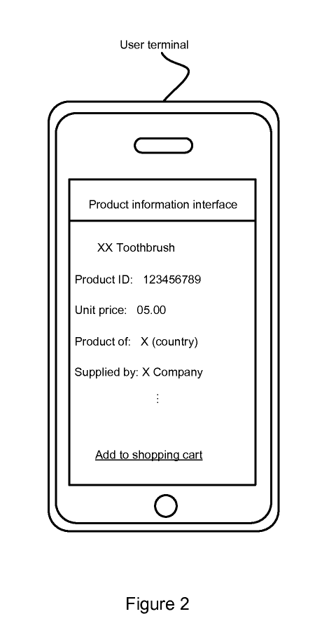

FIG. 2 shows an exemplary user interface consistent with the present disclosure. As shown in FIG. 2, once a user terminal scans the product label information, it may display product information on the user interface. This enables a user to browse more product related information. If the user intends to purchase the product or keep the product information, he may click the “add to shopping cart” button. The user terminal may add the product information into the shopping cart so that the user may access the information or purchase the product later.

In step S102, the user terminal may generate purchase order information based on the product information. The purchase order information may include product information and payment method chosen for purchasing the product. Specifically, if a user decides to purchase the product, the user may use the user terminal to submit a purchase order. The user terminal may generate the purchase order information based on the purchase order and the product information. The purchase order information may include product information and payment method chosen for purchasing the product.

In step S103, the user terminal may send the purchase order information to a trading platform, such as a trading platform hosted by a seller of the product. Specifically, the user terminal may send the purchase order information, which includes a payment method chosen, to the trading platform. The trading platform may manage the purchase process. The method for payment may be payment on delivery, payment on order, or payment on site, etc.

If the payment method is payment on delivery, the trading platform may first obtain the user information and inform a distributor (such as a store) to ship the product. Once the product is shipped and/or received, the trading platform may send the user a payment request, requesting the user to complete the payment process on the trading platform. The payment request may include a link to a payment webpage of the trading platform. If the method for payment is payment on order, the trading platform may send the user a link to the payment webpage. The user may complete the payment process on the trading platform through the payment webpage. The trading platform may then use the user information to arrange shipment of the ordered product. The product may be shipped by a distributor of the product, such as a store. If the method for payment is payment on site, the trading platform may send a link to the payment webpage to the user terminal. The user may complete the payment process through the webpage. The user information may include a contact person's name, phone number, address, etc. for the user.

Embodiments consistent with the present disclosure use a user terminal to scan product label information and to obtain product information; and enable a user to access more information about the product in real time. A user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

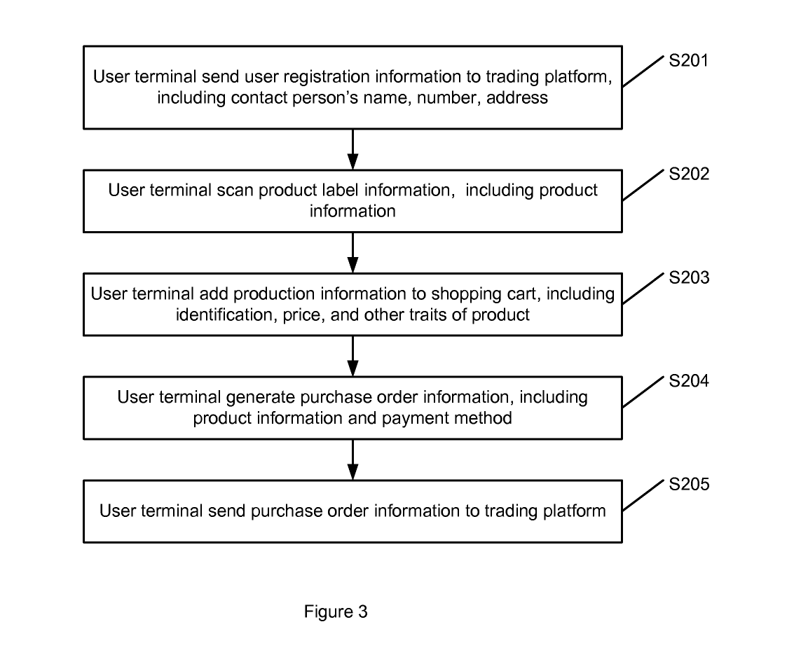

FIG. 3 shows another flow chart for a method of online trading implemented by embodiments consistent with the present disclosure. The method in FIG. 3 is described from the perspective of the user terminal. The method shown in FIG. 3 includes steps S201-S205.

In step S201, the user terminal may send a user's registration information to a trading platform. The registration information may include contact information for the user such as a contact person's name, telephone number, and address. Specifically, a user needs to register with the trading platform before he can make purchases through the platform. The user may use the user terminal to send a request for registration to the trading platform. In response to the request, the trading platform may send a link to the registration webpage. The user may access the webpage and fill in registration information. The user terminal may then send the registration information to the trading platform. The trading platform may then store the registration information and complete the registration process. Upon the completion of the registration process, the user may purchase products through the trading platform.

In some embodiments, for registered users, the user terminal may log in to the user's account before scanning product label information. The registration information may include contact information for the user such as a contact person's name, telephone number, and address. In some embodiments, product sellers/distributors and/or the trading platform hosting companies may use a third party to manage all user data, including the user registration data. For example, a user may register with a third party management company, which may manage multiple online shopping sites or trading platforms. Once the registration is complete, the user may make purchases through a number of or all of the shopping sites and trading platforms managed by the third party data management company. Centralized data management makes it more convenient for the user to make purchases online, or to check prices across a number of websites/platforms. Centralized data management may also enable sellers to monitor prices and avoid potential user confusions.

In step S202, the user terminal may scan the product label information and obtain the product information. In step S203, the user terminal may add the product information into a shopping cart. The product information may include an identification of the product, a price, and other product characteristics. If the user intends to purchase the product or keep the product information, he may click an “add to shopping cart” button. The user terminal may then add the product information into the shopping cart so that the user may access the information or purchase the product later.

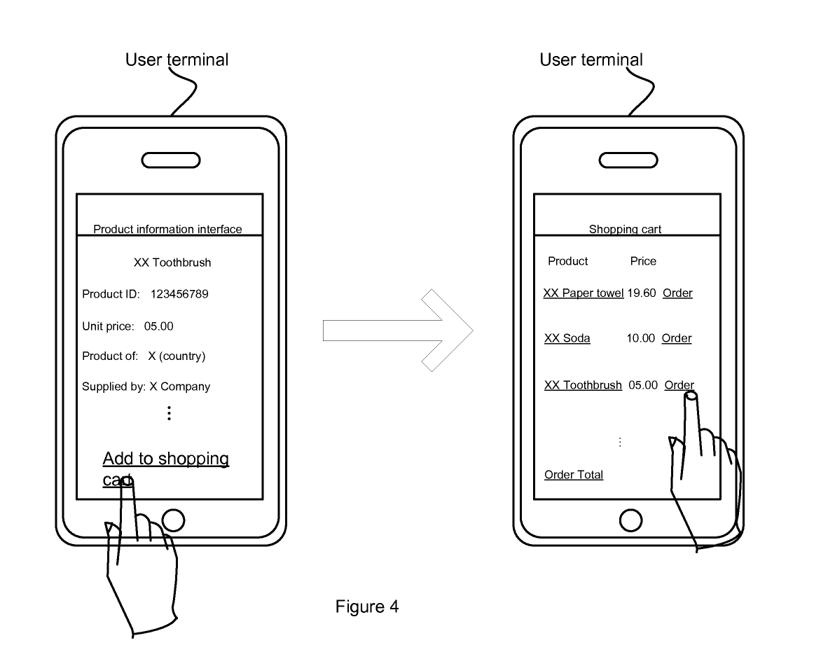

FIG. 4 shows an exemplary user interface for adding product information into a shopping cart. As shown in FIG. 4, when the user terminal displays the product information of a product, the user may click the “add to shopping cart” button on the user terminal, adding the product into his shopping cart. The user terminal may then display the content of the shopping cart. The user may then select the products in the shopping cart to decide whether to purchase one or more of the products in the cart. By clicking an “Order” button, the user may trigger the user terminal to generate purchase order information. In addition, after the user clicks the “Order” button, the user terminal may display a user interface allowing the user to select a payment method. This process makes it convenient for the user to sort out different products. For example, if the user's charge card balance is close to its limit, the user may choose to purchase the more important products first. Once the charge card is paid off, the user can later order the remaining products.

In step S204, the user terminal may generate purchase order information based on product information. The purchase order information includes product information and a selected payment method. In step S205, the user terminal may send the purchase order information to the trading platform. Steps S202, S204, and S205 in FIG. 2 may correspond to steps S101, S102, and S103 shown in FIG. 1.

Embodiments consistent with the present disclosure use user terminals to scan product label information and to obtain product information; and enable a user to access more information about the product in real time. A user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

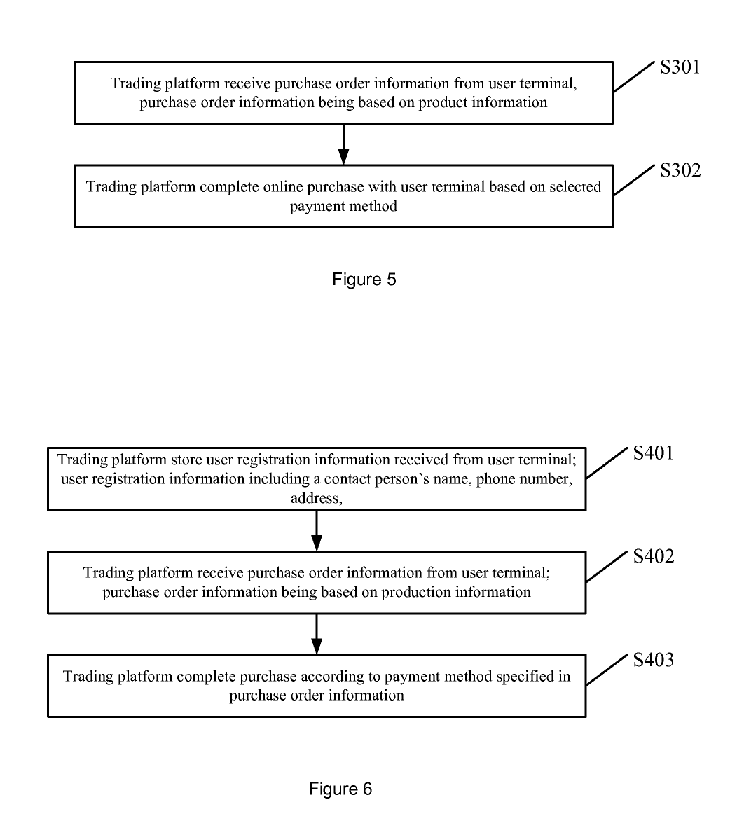

FIG. 5 is a flow chart of a method for online trading implemented by embodiments consistent with the present disclosure. The method shown in FIG. 5 is described from the perspective of a trading platform. The method includes steps S301-S302.

In step S301, the trading platform may receive purchase order information from the user terminal. The user terminal may generate the purchase order information based on product information. Specifically, the user terminal may scan the product label information and obtain the product information. The user terminal may generate purchase order information based on the product information. The purchase order information includes product information and a selected payment method. The method of payment may be payment on delivery, payment on order, or payment on site, etc.

In step S302, the trading platform may complete the online purchase with the user terminal based on the selected payment method. Specifically, if the payment method is payment on delivery, the trading platform may obtain the user information and inform a distributor (such as a store) to ship the product. Once the product is shipped and/or received, the trading platform may send the user a payment request, requesting the user to complete the payment process on the trading platform. The payment request may include a link to a payment webpage of the trading platform. If the method for payment is payment on order, the trading platform may send the user a link to the payment webpage. The user may complete the payment process on the trading platform through the payment webpage. The trading platform may then use the user information to arrange shipment of the ordered product. The product may be shipped by a distributor of the product, such as a store. If the method for payment is payment on site, the trading platform may send a link to the payment webpage to the user terminal. The user may complete the payment process through the webpage. The user information may include a contact person's name, phone number, address, etc. for the user. Moreover, after the payment process and procurement process are completed, the trading platform may update the inventory information of the purchased product.

Embodiments consistent with the present disclosure use a trading platform to complete the transaction based on a payment method specified in the purchase order information. The trading platform may enable the user to choose different payment methods and improve the user experience by providing such flexibility. Such processes further increase the settlement efficiency of product purchases. The user may avoid the need to wait to make purchases at a checkout counter. Embodiments consistent with the present disclosure thus improve user experience in making product purchases and improve the intelligence of the online trading process.

FIG. 6 is a flow chart of a method for online trading implemented by embodiments consistent with the present disclosure. The method shown in FIG. 6 is described from the perspective of a trading platform. The method includes steps S401-S403.

In step S401, the trading platform may store user registration information received from the user terminal. The user registration information may include a contact person's name, phone number, address, etc. Specifically, a user needs to register with the trading platform before he can make purchases through the platform. The user may use the user terminal to send a request for registration to the trading platform. In response to the request, the trading platform may send a link to the registration webpage. The user may access the webpage and fill in registration information. The user terminal may then send the registration information to the trading platform. The trading platform may then store the registration information and complete the registration process. Upon the completion of the registration process, the user may purchase products through the trading platform.

In some embodiments, for registered users, the user terminal may log in to the user's account before scanning product label information. The registration information may include contact information for the user such as a contact person's name, telephone number, and address. The trading platform may authenticate the user based on the user registration information. Once authenticated, the trading platform may send a message to the user terminal indicating that it has logged into the user's account.

In some embodiments, product sellers/distributors and/or the trading platform hosting companies may use a third party to manage all user data, including the user registration data. For example, a user may register with a third party management company, which may manage multiple online shopping sites or trading platforms. Once the registration is complete, the user may make purchases through a number of or all of the shopping sites and trading platforms managed by the third party data management company. Centralized data management makes it more convenient for the user to make purchases online, or to check prices across a number of websites/platforms. Centralized data management may also enable sellers to monitor prices and avoid potential user confusions.

In step S402, the trading platform may receive purchase order information from the user terminal. The purchase order information may be based on the product information of the product. In step 403, the trading platform may complete the purchase according to the payment method specified in the purchase order information.

Embodiments consistent with the present disclosure use a trading platform to complete the transaction based on a payment method specified in the purchase order information. The trading platform may enable the user to choose different payment methods and improve the user experience by providing such flexibility. Such processes further increase the settlement efficiency of product purchases. The user may avoid the need to wait to make purchases at a checkout counter. Embodiments consistent with the present disclosure thus improve user experience in making product purchases and improve the intelligence of the online trading process.

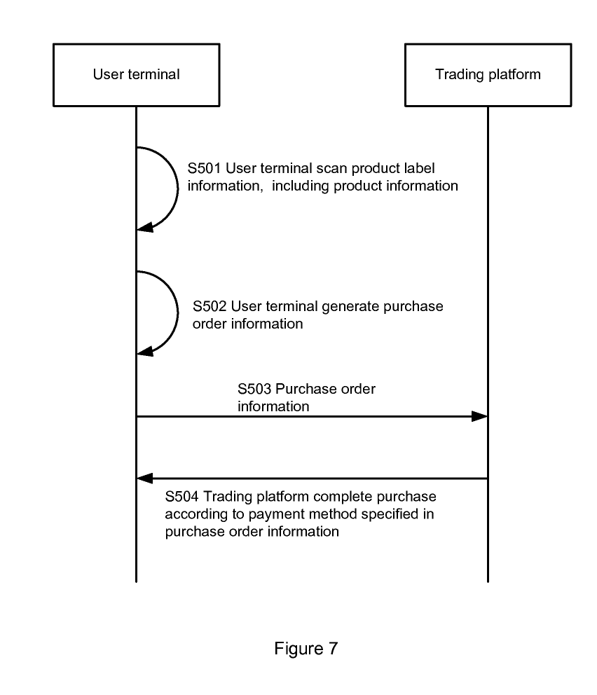

FIG. 7 is a flow chart of a method for online trading implemented by embodiments consistent with the present disclosure. The method shown in FIG. 7 is described from the perspectives of both the user terminal and trading platform. The method includes steps S501-S504.

In step S501, a user terminal may scan the label information of a product. The label information may include product information. Specifically, a user may use a user terminal to scan a product he intends to purchase. Once the user terminal reads in the product label information, the user terminal may obtain more product information based on the label information. For example, the label information may be graphic code information. The user terminal may use a camera and/or a scanner to obtain the label information. The user terminal may use an instant messaging software application such as a graphics code scanning application to scan the label information. Alternatively, if the product label is a NFC tag, the user terminal may use a software/hardware application that facilitates reading/writing of NFC tags to scan the label information. That is, in this case, the instant messaging application used for scanning is the NFC read/write software/hardware application.

In step S502, the user terminal may generate purchase order information based on the product information. The purchase order information includes product information and payment method chosen for purchasing the product. Specifically, if a user decides to purchase the product, the user may use the user terminal to submit a purchase order. The user terminal may generate the purchase order information based on the purchase order and the product information. The purchase order information may include product information and payment method chosen for purchasing the product.

In step S503, the user terminal may send the purchase order information to a trading platform, such as a trading platform hosted by a seller of the product. Specifically, the user terminal may send the purchase order information, which includes a payment method chosen, to the trading platform. The trading platform may manage the purchase process. The method for payment may be payment on delivery, payment on order, or payment on site, etc.

In step S504, the trading platform may complete the online purchase with the user terminal based on the selected payment method. Specifically, if the payment method is payment on delivery, the trading platform may obtain the user information and inform a distributor (such as a store) to ship the product. Once the product is shipped and/or received, the trading platform may send the user a payment request, requesting the user to complete the payment process on the trading platform. The payment request may include a link to a payment webpage of the trading platform. If the method for payment is payment on order, the trading platform may send the user a link to the payment webpage. The user may complete the payment process on the trading platform through the payment webpage. The trading platform may then use the user information to arrange shipment of the ordered product. The product may be shipped by a distributor of the product, such as a store. If the method for payment is payment on site, the trading platform may send a link to the payment webpage to the user terminal. The user may complete the payment process through the webpage. The user information may include a contact person's name, phone number, address, etc. for the user. Moreover, after the payment process and procurement process are completed, the trading platform may update the inventory information of the purchased product.

Embodiments consistent with the present disclosure use a trading platform to complete the transaction based on a payment method specified in the purchase order information. The user terminal and trading platform may enable the user to choose different payment methods and improve the user experience by providing such flexibility. Such processes further increase the settlement efficiency of product purchases. The user may avoid the need to wait to make purchases at a checkout counter. Embodiments consistent with the present disclosure thus improve user experience in making product purchases and improve the intelligence of the online trading process.

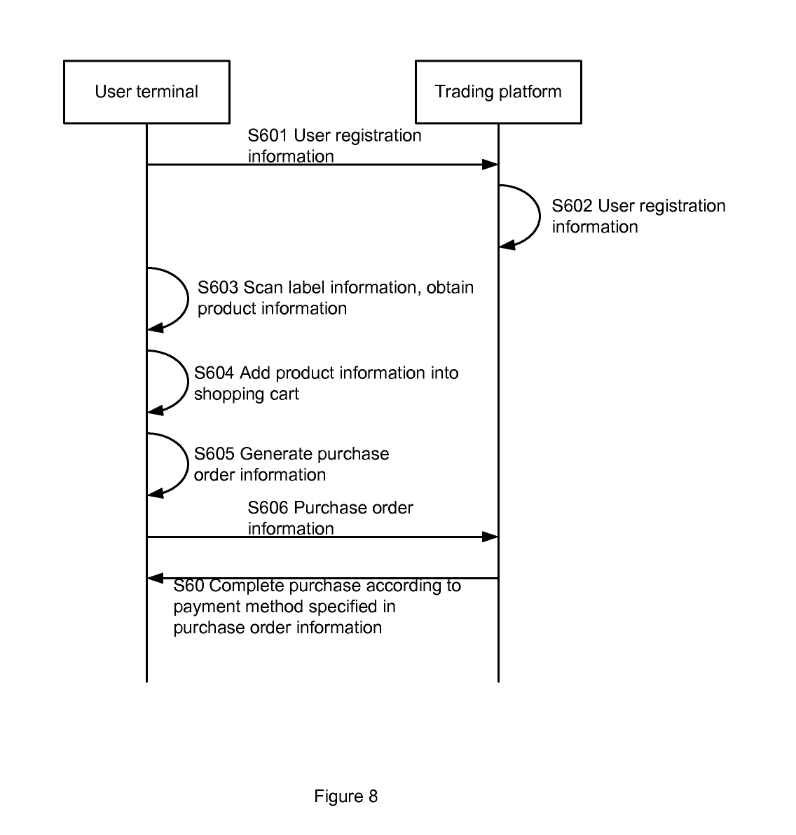

FIG. 8 is a flow chart of a method for online trading implemented by embodiments consistent with the present disclosure. The method shown in FIG. 8 is described from the perspectives of both the user terminal and trading platform. The method includes steps S601-S607.

In step S601, the user terminal may send a user's registration information to a trading platform. The registration information may include contact information for the user such as a contact person's name, telephone number, and address. Specifically, a user needs to register with the trading platform before he can make purchases through the platform. The user may use the user terminal to send a request for registration to the trading platform. In response to the request, the trading platform may send a link to the registration webpage. The user may access the webpage and fill in registration information. The user terminal may then send the registration information to the trading platform. The trading platform may then store the registration information and complete the registration process. Upon the completion of the registration process, the user may purchase products through the trading platform.

In some embodiments, for registered users, the user terminal may log in to the user's account before scanning product label information. The registration information may include contact information for the user such as a contact person's name, telephone number, and address. In some embodiments, product sellers/distributors and/or the trading platform hosting companies may use a third party to manage all user data, including the user registration data. For example, a user may register with a third party management company, which may manage multiple online shopping sites or trading platforms. Once the registration is complete, the user may make purchases through a number of or all of the shopping sites and trading platforms managed by the third party data management company. Centralized data management makes it more convenient for the user to make purchases online, or to check prices across a number of websites/platforms. Centralized data management may also enable sellers to monitor prices and avoid potential user confusions.

In step S602, the trading platform may store user registration information received from the user terminal. The user registration information may include a contact person's name, phone number, address, etc. Specifically, a user needs to register with the trading platform before he can make purchases through the platform. The trading platform may authenticate the user based on the user registration information. Once authenticated, the trading platform may send a message to the user terminal indicating that it has logged into the user's account.

In step S603, the user terminal may scan the product label information. The label information includes product information. In step S604, the user terminal may add the product information into a shopping cart. The product information includes an identification of the product, a price of the product, and other traits of the product. Specifically, once a user terminal scans the product label information, it may display product information on the user interface.

This enables a user to browse more product related information. If the user intends to purchase the product or keep the product information, he may click the “add to shopping cart” button. The user terminal may add the product information into the shopping cart so that the user may access the information or purchase the product later.

In step S605, the user terminal may generate purchase order information. The purchase order information includes product information and a selected payment method for the product. In step S606, the user terminal may send the purchase order information to the trading platform. In step S607, the trading platform may complete the online purchase according to the payment method specified in the purchase order information.

In the above example, steps S603, S605, S606 and S607 may correspond to steps S501, S502, S503, and S504, which are not repeated herewith.

Embodiments consistent with the present disclosure use user terminals to scan product label information and to obtain product information; and enable a user to access more information about the product in real time. The user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

FIGS. 9-11 below illustrate a number of embodiments of a user terminal consistent with the present disclosure. The user terminals illustrated in FIGS. 9-11 may be used to implement the methods shown in FIGS. 1-4. To better describe the user terminal, only the components relevant to the examples in relation to FIGS. 9-11 are discussed. Other functions and components of the user terminal may be disclosed in the embodiments discussed in relation to FIGS. 1-4.

FIG. 9 is a block diagram of an exemplary user terminal consistent with the present disclosure. As shown in FIG. 9, a user terminal 1 may include an obtaining unit 11, a generating unit 12, and a purchase order sending unit 13.

The user terminal 1 may scan the label information of a product. The label information may include product information. Specifically, a user terminal 1 may use the obtaining unit 11 to scan a product he intends to purchase. Once the obtaining unit 11 reads in the product label information, it may obtain product information based on the label information. For example, the label information may be graphic code information. The obtaining unit 11 may use a camera and/or a scanner to obtain the label information. The obtaining unit 11 may use an instant messaging software application such as a graphics code scanning application to scan the label information. Alternatively, if the product label is a NFC tag, the obtaining unit 11 may use a software/hardware application that facilitates reading/writing of NFC to scan the label information. That is, in this case, the instant messaging application used for scanning is the NFC read/write application.

The generating unit 12 of the user terminal 1 may generate purchase order information based on the product information. The purchase order information includes product information and payment method chosen for purchasing the product. Specifically, if a user decides to purchase the product, the user may use the user terminal 1 to submit a purchase order. The generating unit 12 may generate the purchase order information based on the purchase order and the product information. The purchase order information may include product information and payment method chosen for purchasing the product.

The purchase order sending unit 13 of the user terminal 1 may send the purchase order information to a trading platform, such as a trading platform hosted by a seller of the product. Specifically, the purchase order sending unit 13 may send the purchase order information, which includes a payment method chosen, to the trading platform. The trading platform may manage the purchase process. The method for payment may be payment on delivery, payment on order, or payment on site, etc.

If the payment method is payment on delivery, the trading platform may obtain the user information and inform a distributor (such as a store) to ship the product. Once the product is shipped and/or received, the trading platform may send the user a payment request, requesting the user to complete the payment process on the trading platform. The payment request may include a link to a payment webpage of the trading platform. If the method for payment is payment on order, the trading platform may send the user a link to the payment webpage. The user may complete the payment process on the trading platform through the payment webpage. The trading platform may then use the user information to arrange shipment of the ordered product. The product may be shipped by a distributor of the product, such as a store. If the method for payment is payment on site, the trading platform may send a link to the payment webpage to the user terminal 1. The user may complete the payment process through the webpage. The user information may include a contact person's name, phone number, address, etc. for the user.

Embodiments consistent with the present disclosure use user terminals to scan product label information and to obtain product information; and enable a user to access more information about the product in real time. A user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

FIG. 10 is a block diagram of an exemplary user terminal consistent with the present disclosure. As shown in FIG. 10, a user terminal 1 may include an obtaining unit 11, a generating unit 12, a purchase order sending unit 13, a registration sending unit 14, and an adding unit 15. The operations of generating unit 12 and purchase order sending unit 13 are described above, and will not be repeated here.

The registration sending unit 14 of the user terminal 1 may send a user's registration information to a trading platform. The registration information may include contact information for the user such as a contact person's name, telephone number, and address. Specifically, a user needs to register with the trading platform before he can make purchases through the platform. The user may use the registration sending unit 14 of the user terminal 1 to send a request for registration to the trading platform. In response to the request, the trading platform may send a link to the registration webpage. The user may access the webpage and fill in registration information. The registration sending unit 14 may then send the registration information to the trading platform. The trading platform may then store the registration information and complete the registration process. Upon the completion of the registration process, the user may purchase products through the trading platform.

In some embodiments, for registered users, the user terminal 1 may log in to the user's account before scanning product label information. The registration information may include contact information for the user such as a contact person's name, telephone number, and address. In some embodiments, product sellers/distributors and/or the trading platform hosting companies may use a third party to manage all user data, including the user registration data. For example, a user may use registration sending unit 14 to register with a third party management company, which may manage multiple online shopping sites or trading platforms. Once the registration is complete, the user may make purchases through a number of or all of the shopping sites and trading platforms managed by the third party data management company. Centralized data management makes it more convenient for the user to make purchases online, or to check prices across a number of websites/platforms. Centralized data management may also enable sellers to monitor prices and avoid potential user confusions.

The adding unit 15 may add product information into a user's shopping cart. When the user terminal 1 displays the product information of a product, the user may click the “add to shopping cart” button on the user terminal, adding the product into his shopping cart. The user terminal 1 may then display the content of the shopping cart. The user may then select the products in the shopping cart to decide whether to purchase one or more of the products in the cart.

Embodiments consistent with the present disclosure use user terminals to scan product label information and to obtain product information; and enable a user to access more information about the product in real time. A user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

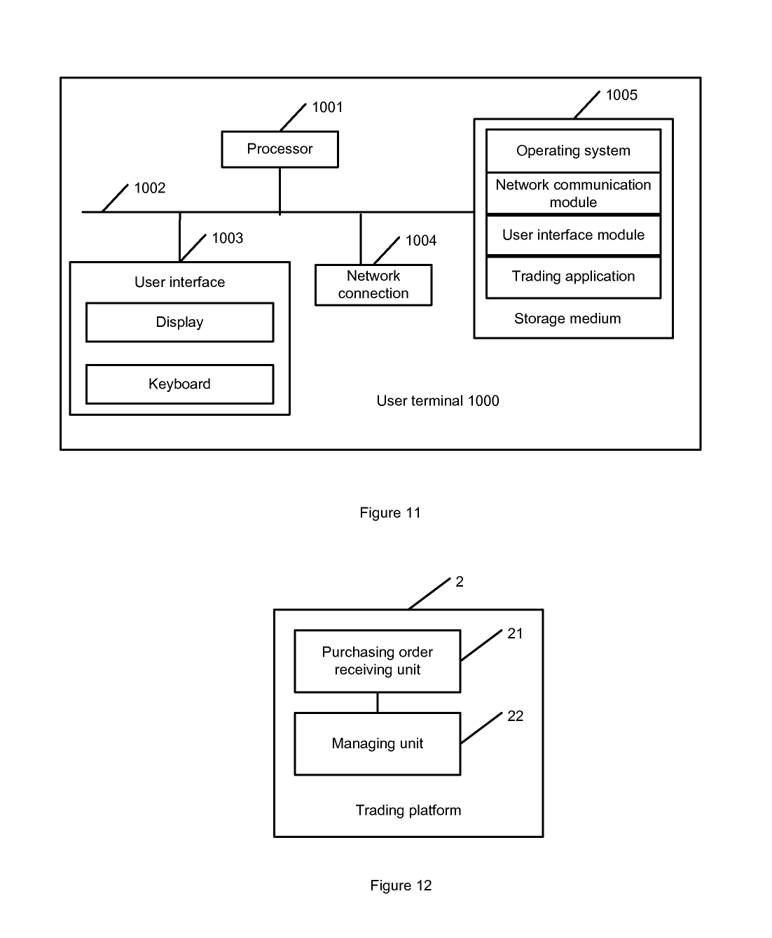

FIG. 11 is another schematic diagram of a user terminal 1000 consistent with the present disclosure. As shown in FIG. 11, the user terminal may include a processor 1001, such as a CPU, a network connection 1004, a user interface 1003, storage medium 1005, and a bus 1002. Processor 1001 may include any appropriate processor or processors. Further, processor 1001 can include multiple cores for multi-thread or parallel processing. Storage medium 1005 may include memory modules, such as Read-only Memory (ROM), Random Access Memory (RAM), flash memory modules, and erasable and rewritable memory, and mass storages, such as CD-ROM, U-disk, and hard disk, etc. Storage medium 1005 may store computer programs for implementing various processes, when executed by processor 1001, including the operating system, communication program modules, and other application modules used to implement the system for making secure online payments consistent with the present disclosure. The network connection 1004 may connect to any appropriate type of communication networks, including the Internet, LAN (Local Area Network), or other types of computer networks or telecommunication networks, either wired or wireless. For example, the network connection 1004 may connect the online trading platform to the user terminal, so that a user may complete transactions seamlessly.

In FIG. 11, the network connection 1004 may be used to connect the trading platform and the user terminal 1000. The network connection 1004 may transfer data between the trading platform and the user terminal 1000. In addition, the processor 1001 may execute the application programs stored in the storage medium 1005 to implement online purchase and payment functions.

In some embodiments, before sending a request for making a payment, the network connection 1004 may connect the user terminal 1000 to the trading platform. The network connection 1004 may also communicate with the user terminal 1000. The user interface 1003 may provide an interface for a user to enter information using a display and/or a keyboard. The processor 1001 may execute the online trading application programs stored in storage medium 1005 to implement the following online purchase method.

The user terminal 1000 may scan the label information of a product. The label information may include product information. The user terminal 1000 may generate purchase order information based on the product information. The purchase order information includes product information and payment method chosen for purchasing the product. Finally, the user terminal 1000 may send the purchase order information to a trading platform, such as a trading platform hosted by a seller of the product.

In one embodiment, after obtaining the product information, the processor 1001 may further execute the following steps. The user terminal 1000 may add the product information into a shopping cart. The product information includes an identification and a price of the product, as well as other traits of the product. In one embodiment, before the processor 1001 scans the product label information, it may execute the following steps. The user terminal 1000 may send user registration information to the trading platform. The user registration information includes a contact person's name, telephone number, address, etc. In some embodiments, the product label information may be a two-dimensional code or NFC information.

Embodiments consistent with the present disclosure use user terminals to scan product label information and to obtain product information; and enable a user to access more information about the product in real time. A user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

FIGS. 12-14 below illustrate a number of embodiments of a trading platform consistent with the present disclosure. The trading platform illustrated in FIGS. 12-14 may be used to implement the methods shown in FIGS. 5 and 6. To better describe the user terminal, only the components relevant to the examples in relation to FIG. 12-14 are discussed. Other functions and components of the trading platform may be disclosed in the embodiments discussed in relation to FIGS. 5 and 6.

FIG. 12 is a block diagram of an exemplary trading platform consistent with the present disclosure. As shown in FIG. 12, a trading platform 2 may include a purchase order receiving unit 21 and a managing unit 22.

The purchase order receiving unit 21 of the trading platform 2 may receive purchase order information from the user terminal. The user terminal may generate the purchase order information based on product information. Specifically, the user terminal may scan the product label information and obtain the product information. The user terminal may generate purchase order information based on the product information and send the purchase order information to the receiving unit 21 of the trading platform 2. The purchase order information includes product information and a selected payment method. The method of payment may be payment on delivery, payment on order, or payment on site, etc.

The managing unit 22 of the trading platform 2 may manage the payment process according to the payment method specified in the purchase order information and complete the online purchase process. If the payment method is payment on delivery, the managing unit 22 may obtain the user information and inform a distributor (such as a store) to ship the product. Once the product is shipped and/or received, the managing unit 22 may send the user a payment request, requesting the user to complete the payment process on the trading platform. The payment request may include a link to a payment webpage of the trading platform. If the method for payment is payment on order, the managing unit 22 may send the user a link to the payment webpage. The user may complete the payment process on the trading platform through the payment webpage. The trading platform may then use the user information to arrange shipment of the ordered product. The product may be shipped by a distributor of the product, such as a store. If the method for payment is payment on site, the trading platform may send a link to the payment webpage to the user terminal. The user may complete the payment process through the webpage. The user information may include a contact person's name, phone number, address, etc. for the user. Moreover, after the payment process and procurement process are completed, the trading platform 2 may update the inventory information of the purchased product.

Embodiments consistent with the present disclosure use a trading platform to complete the transaction based on a payment method specified in the purchase order information. The trading platform may enable the user to choose different payment methods and improve the user experience by providing such flexibility. Such processes further increase the settlement efficiency of product purchases. The user may avoid the need to wait to make purchases at a checkout counter. Embodiments consistent with the present disclosure thus improve user experience in making product purchases and improve the intelligence of the online trading process.

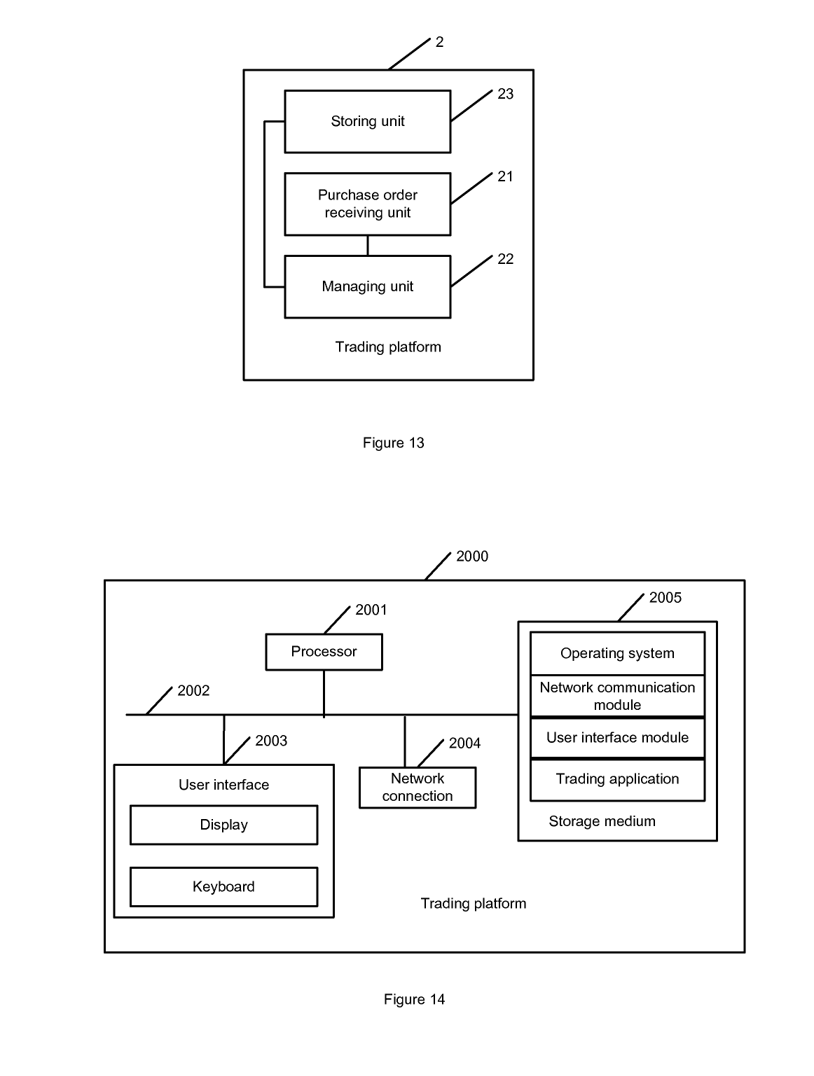

FIG. 13 is a block diagram of an exemplary trading platform consistent with the present disclosure. As shown in FIG. 13, a trading platform 2 may include a purchase order receiving unit 21, a managing unit 22, and a storing unit 23. The purchase order receiving unit 21 and management unit 22 are discussed above in relation to FIG. 12 and will not be repeated below.

The storing unit 23 may be used to store user registration information sent by the user terminal. The user registration information may include a contact person's name, phone number, address, etc. Specifically, a user needs to register with the trading platform 2 before he can make purchases through the platform. The user may use the user terminal to send a request for registration to the trading platform. In response to the request, the trading platform 2 may send a link to the registration webpage. The user may access the webpage and fill in registration information. The user terminal may then send the registration information to the trading platform 2. The storing unit 23 of the trading platform 2 may then store the registration information and complete the registration process. Upon the completion of the registration process, the user may purchase products through the trading platform.

In some embodiments, for registered users, the user terminal may log in to the user's account before scanning product label information. The registration information may include contact information for the user such as a contact person's name, telephone number, and address. The trading platform may authenticate the user based on the user registration information. Once authenticated, the trading platform 2 may send a message to the user terminal indicating that it has logged into the user's account.

In some embodiments, product sellers/distributors and/or the trading platform hosting companies may use a third party to manage all user data, including the user registration data. For example, a user may register with a third party management company, which may manage multiple online shopping sites or trading platforms. Once the registration is complete, the user may make purchases through a number of or all of the shopping sites and trading platforms managed by the third party data management company. Centralized data management makes it more convenient for the user to make purchases online, or to check prices across a number of websites/platforms. Centralized data management may also enable sellers to monitor prices and avoid potential user confusions.

Embodiments consistent with the present disclosure use a trading platform to complete the transaction based on a payment method specified in the purchase order information. The trading platform may enable the user to choose different payment methods and improve the user experience by providing such flexibility. Such processes further increase the settlement efficiency of product purchases. The user may avoid the need to wait to make purchases at a checkout counter. Embodiments consistent with the present disclosure thus improve user experience in making product purchases and improve the intelligence of the online trading process.

FIG. 14 is another schematic diagram of trading platform 2000 consistent with the present disclosure. As shown in FIG. 14, the trading platform 2000 may include a processor 2001, such as a CPU, a network connection 2004, a user interface 2003, storage medium 2005, and a bus 2002. Processor 2001 may include any appropriate processor or processors. Further, processor 2001 can include multiple cores for multi-thread or parallel processing. Storage medium 2005 may include memory modules, such as Read-only Memory (ROM), Random Access Memory (RAM), flash memory modules, and erasable and rewritable memory, and mass storages, such as CD-ROM, U-disk, and hard disk, etc. Storage medium 2005 may store computer programs for implementing various processes, when executed by processor 2001, including the operating system, communication program modules, and other application modules used to implement the system for making online purchases consistent with the present disclosure. The network connection 2004 may connect to any appropriate type of communication networks, including the Internet, LAN (Local Area Network), or other types of computer networks or telecommunication networks, either wired or wireless. For example, the network connection 1004 may connect the online trading platform to the payment platform, so that a user may complete transactions seamlessly.

In FIG. 14, the network connection 2004 may be used to connect the trading platform 2000 and the user terminal 1000. The network connection 2004 may transfer data between the trading platform 2000 and the user terminal 1000. The user interface 2003 may be used to allow user to enter input, through a display or a keyboard. The trading platform 2000 may obtain user input data through user interface 2003. In addition, the processor 2001 may execute the application programs stored in the storage medium 2005 to implement online shopping functions.

In one embodiment, the processor 2001 may execute the following steps before receiving purchase order information from the user terminal. The trading platform 2000 may receive user registration information from the user terminal. The user registration information includes a contact person's name, telephone number, address, etc. In one embodiment, the processor 2001 may execute the following payment steps and manage the online purchase process.

The trading platform 2000 may manage the payment process according to the payment method specified in the purchase order information and complete the online purchase process. If the payment method is payment on delivery, the trading platform 2000 may obtain the user information and inform a distributor (such as a store) to ship the product. Once the product is shipped and/or received, the trading platform 2000 may send the user a payment request, requesting the user to complete the payment process on the trading platform. The payment request may include a link to a payment webpage of the trading platform. If the method for payment is payment on order, the trading platform 2000 may send the user a link to the payment webpage. The user may complete the payment process on the trading platform 2000 through the payment webpage. The trading platform 2000 may then use the user information to arrange shipment of the ordered product. The product may be shipped by a distributor of the product, such as a store. If the method for payment is payment on site, the trading platform may send a link to the payment webpage to the user terminal. The user may complete the payment process through the webpage. The user information may include a contact person's name, phone number, address, etc. for the user. Moreover, after the payment process and procurement process are completed, the trading platform may update the inventory information of the purchased product.

Embodiments consistent with the present disclosure use user terminals to scan product label information and to obtain product information; and enable a user to access more information about the product in real time. The user terminal may generate purchase order information based on product information and send the purchase order information to a trading platform. The trading platform may complete the transaction based on a payment method specified in the purchase order information. The user terminal may enable the user to choose different payment methods. Such processes increase the settlement efficiency of product purchases. The user may avoid the need to wait to make purchases at a checkout counter. Embodiments consistent with the present disclosure thus improve user experience in making product purchases and improve the intelligence of the online trading process.

Consistent with embodiments of the present disclosure, one or more non-transitory storage medium storing a computer program are provided to implement the system and method for conducting online transactions. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as

DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for online transactions may be implemented. For example, users in an instant messaging session may use an online trading system to purchase services and/or products. The online trading system may have a user interface through the instant messaging session. The user may enter information and initiate purchases through the user interface. The device hosting the instant messaging session may include a camera, a scanner, a touch pad, or other communication modules. The device may scan a product's label to obtain the product identification and other information. The device may also obtain additional product information based on the product identification from databases. The device may present the product information obtained after scanning the product label. The user may choose to add the product into a shopping cart. The content of the shopping cart may be stored on the device. The user may later browse the products in his shopping cart and select to purchase one or more of the products. The user may also select a payment method for the purchase. The device may generate purchase order information and send the purchase order information to a trading platform. The trading platform may complete the purchase based on the payment method specified. In another example, the online trading system may be implemented by an application on a smart device. A user may launch the shopping application to scan product labels, browse product information, and shop for different products. The application may have a user interface that is separate from an instant messaging user interface.

Embodiments consistent with the present disclosure may be used to implement shopping systems in stores or supermarkets as well as certain online shopping sites/systems.

What is claimed is:

1. A method for conducting online transactions implemented by a user terminal, comprising:
scanning a product label of a product and obtaining product label information;
obtaining product information based on the product label information;
generating purchase order information based on the product information, the purchase order information including an identification of the product and a payment method for the purchase;
sending the purchase order information to a trading platform; and
receiving a message indicating the purchase is complete.

2. The method according to claim 1, further comprising:
adding the product information to a shopping cart, the product information including an identification, a price, and data related to other traits of the product.

3. The method according to claim 1, further comprising:
sending user registration information to the trading platform, the user registration information including a contact person's name, telephone number, and address.

4. The method according to claim 1, wherein the payment method is payment on delivery, payment on order, or payment on site.

5. The method according to claim 4, wherein the product label information includes an identification of the product based on a graphic code or NFC technology.

6. A method for conducting online transactions implemented by an online trading platform, comprising:
receiving user registration information from a user terminal, the registration information including a contact person's name, telephone number, and address;
storing the user registration information;
receiving purchase order information from a user terminal, the purchase order information including an identification of a product, a price, and a payment method;
managing payment process according to the payment method; and
completing the purchase based on the purchase order information.

7. The method according to claim 6, further comprising:
authenticating a user based on the user registration information.

8. The method according to claim 6, wherein the payment method is payment on delivery, further comprising:
distributing the product using the user registration information; and
sending a payment interface to the user terminal after distributing the product.

9. The method according to claim 6, wherein the payment method is payment on order, further comprising:
sending a payment interface to the user terminal; and
distributing the product using the user registration information after sending the payment interface.

10. The method according to claim 6, wherein the payment method is payment on site, further comprising:
sending a payment interface to the user terminal.

11. The method according to claim 10, further comprising:
sending a message to the user terminal indicating the purchase is complete.

12. A system for conducting online transactions, comprising:
a user terminal configured to scan a product label of a product and obtaining product label information; obtain product information based on the product label information; generate purchase order information based on the product information, the purchase order information including a payment method; send the purchase order information to a trading platform; and receive a message from the trading platform indicating the purchase is complete.

13. The system according to claim 12, wherein the user terminal is further configured to add the product information to a shopping cart, the product information including an identification, a price, and data related to other traits of the product.

14. The system according to claim 12, wherein the user terminal is further configured to send user registration information to the trading platform, the user registration information including a contact person's name, telephone number, and address.

15. The system according to claim 12, wherein the payment method is payment on delivery, payment on order, or payment on site.

16. The system according to claim 15, wherein the product label information includes a product identification based on a graphic code or NFC technology.

17. The system according to claim 12, further comprising:
a trading platform configured to receive user registration information from the user terminal, the registration information including a contact person's name, telephone number, and address; store the user registration information; receive purchase order information from the user terminal, the purchase order information including an identification of a product, a price, and a payment method; manage payment process according to the payment method; and complete the purchase based on the purchase order information.

18. The system according to claim 17, wherein the trading platform is further configured to authenticate a user based on the user registration information.
